(19) United States
(12) Patent Application Publication
(10) Pub. No.: US 2026/0184286 A1
(43) Pub. Date: Jul. 2, 2026

(54) ACCESS CONTROL DEVICE, ACCESS CONTROL METHOD, AND STORAGE MEDIUM STORING PROGRAM

(71) Applicant: DENSO CORPORATION, Kariya-city (JP)

(72) Inventors: Hideyuki HONYA, Kariya-city (JP); Yasuaki KURITA, Kariya-city (JP); Kei OKADA, Kariya-city (JP); Hideyuki YAMAGUCHI, Kariya-city (JP)

(21) Appl. No.: 19/548,717

(22) Filed: Feb. 24, 2026

Related U.S. Application Data
(63) Continuation of application No. PCT/JP2024/030822, filed on Aug. 28, 2024.

(30) Foreign Application Priority Data
Aug. 31, 2023 (JP) 2023-141359

(51) Int. Cl. B60R 25/24; B60R 25/01; B60R 25/33

(52) U.S. Cl. CPC B60R 25/241; B60R 25/01; B60R 25/33

(57) ABSTRACT

An access control device is mounted on a vehicle and configured to: accept an access request to at least one application programming interface of application programming interfaces each corresponding to vehicle data or a function of the vehicle, from an application; acquire movement information indicating that the vehicle has moved from a first region to a second region; and control the access request based on an authorization policy that defines an access privilege from the application to each application programming interface according to a region, and change a control of the access request.

### CROSS REFERENCE TO RELATED APPLICATIONS

The present application is a continuation application of International Patent Application No. PCT/JP2024/030822 filed on Aug. 28, 2024, which designated the U.S. and claims the benefit of priority from Japanese Patent Application No. 2023-141359 filed on Aug. 31, 2023. The entire disclosures of all of the above applications are incorporated herein by reference.

### TECHNICAL FIELD

The present disclosure relates to a technology for controlling access.

### BACKGROUND

A comparative technology has been known in which, in an open platform for mobile terminals, access is restricted based on an access authorization policy when access to resources or data held by the mobile terminals via a service application is detected. The access authorization policy stipulates “who” is permitted or prohibited from doing “what” to “what”.

### SUMMARY

According to an aspect of the present disclosure, an access control device is mounted on a vehicle and comprises: at least one of (i) a circuit and (ii) a processor with a memory storing computer program code executable by the processor, the at least one of the circuit and the processor configured to cause the access control device to: accept an access request to at least one application programming interface of application programming interfaces each corresponding to vehicle data or a function of the vehicle, from an application; and acquire movement information indicating that the vehicle has moved from a first region to a second region; and a controller configured to control the access request based on an authorization policy that defines an access privilege from the application to each application programming interface according to a region, and change a control of the access request.

### BRIEF DESCRIPTION OF DRAWINGS

FIG. 1 is a block diagram showing a configuration of a mobility service provision system.

FIG. 2 is a block diagram showing a configuration of an ECU.

FIG. 3 is a block diagram showing a functional configuration of an in-vehicle system.

FIG. 4 is a block diagram showing a configuration of an API gateway.

FIG. 5 is a diagram for illustrating contents of user information.

FIG. 6 is a diagram showing an example of an authorization policy for each region.

FIG. 7 is a diagram showing an example of a correspondence between a country and group attributes.

FIG. 8 is a diagram showing an example of the authorization policy related to safety.

FIG. 9 is a diagram showing an example of the authorization policy related to corporate assets.

FIG. 10 is a diagram showing an example of the authorization policy related personal assets.

FIG. 11 is a diagram showing an example of the authorization policy related privacy.

FIG. 12 is a flowchart showing an access control process executed by a request acceptance unit, an acquisition unit, and a controller.

### DETAILED DESCRIPTION

In the future, it is expected that an unspecified number of third-party service applications will be installed in electronic control systems of vehicles. When a third-party service application accesses functions and information of a vehicle, it is required to limit access according to an environment related to the vehicle in a region in which the vehicle is traveling.

As a result of detailed study by the inventor, it has been found that an environment related to the vehicle is different for each region, and it is difficult for a third party to develop a service application capable of understanding the environment related to the vehicle for each region and implementing precise access control according to the environment.

One aspect of the present disclosure is desirable to implement precise access control according to an environment of a region while reducing the burden on application providers.

An access control device according to an aspect of the present disclosure is mounted on a vehicle and includes a request acceptance unit, an acquisition unit, and a controller. The request reception unit accepts an access request to each of at least one application programming interface of a plurality of application programming interfaces each corresponding to the vehicle data or a function of the vehicle from an application that uses vehicle data or the function of the vehicle via the at least one application programming interface. The acquisition unit acquires movement information indicating that the vehicle has moved from a first region to a second region. The controller controls the access request to each of the at least one application programming interface based on an authorization policy that defines an access privilege from the application to each of the plurality of application programming interfaces according to a region. The controller changes control of the access request to each of the at least one application programming interface when the movement information is acquired by the acquisition unit.

According to an aspect of the present disclosure, the access control device automatically changes the control of the access request based on detection of the movement of the vehicle. Therefore, the application provider does not need to adapt the application to the vehicle environment in various regions. Accordingly, it is possible to implement precise access control according to the environment of the region while reducing the burden on application providers.

An access control method according to another aspect of the present disclosure is executed by an in-vehicle device mounted on a vehicle, and comprises: accepting an access request to each of at least one application programming interface of a plurality of application programming interfaces each corresponding to the vehicle data or a function of the vehicle from an application that uses vehicle data or the function of the vehicle via the at least one application programming interface; acquiring movement information indicating that the vehicle has moved from a first region to a second region; controlling the access request to each of the at least one application programming interface based on an authorization policy that defines an access privilege from the application to each of the plurality of application programming interfaces according to a region; and changing control of the access request to each of the at least one application programming interface when the movement information is acquired.

When the access control method described above is executed by the in-vehicle device, the similar effects to those of the access control device described above are achieved.

A program of yet another aspect of the present disclosure causes an in-vehicle device mounted on a vehicle to: accept an access request to each of at least one application programming interface of a plurality of application programming interfaces each corresponding to the vehicle data or a function of the vehicle from an application that uses vehicle data or the function of the vehicle via the at least one application programming interface; acquire movement information indicating that the vehicle has moved from a first region to a second region; control the access request to the at least one application programming interface based on an authorization policy that defines an access privilege from the application to each of the plurality of application programming interfaces according to a region; and change control of the access request to each of the at least one application programming interface when the vehicle movement information is acquired.

The in-vehicle device executes the above program to provide the same effects as those of the access control device.

### Embodiment

Hereinafter, an embodiment of the present disclosure will be described with reference to the drawings.

### 1. Configuration

### (1-1. Configuration of Mobility Service Provision System)

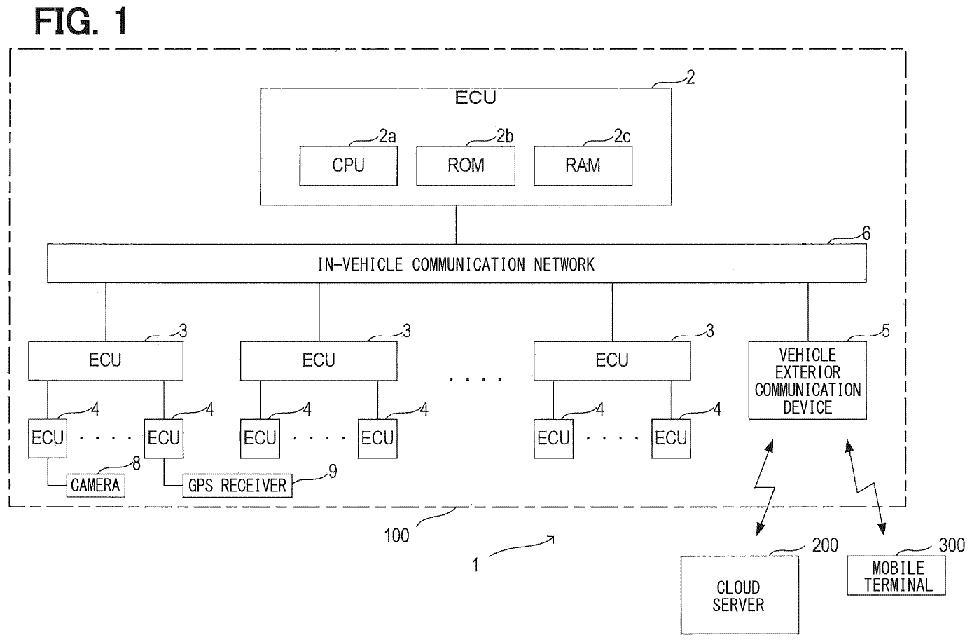

A configuration of a mobility service provision system 1 according to the present embodiment will be described with reference to FIG. 1. The mobility service provision system 1 includes an in-vehicle system 100 mounted in a vehicle, a cloud server 200, and a mobile terminal 300. The vehicle may be capable of both manual driving and automated driving, or may be capable of only manual driving or automated driving. The vehicle may be a hybrid vehicle including an engine and an electric motor as a traveling drive source. The vehicle may be a vehicle having only one of an engine and an electric motor as a traveling drive source.

As shown in FIG. 1, the in-vehicle system 100 includes one electronic control unit (hereinafter referred to as ECU) 2, multiple ECUs 3, multiple ECUs 4, a vehicle exterior communication device 5, a vehicle interior communication network 6, a camera 8, and a GPS receiver 9.

The ECU 2 has a function of relaying frames flowing through the vehicle interior communication network 6, and controls multiple ECUs 3 to implement coordinated control of the entire vehicle.

The ECU 2 includes a microcomputer including a CPU 2a, a ROM 2b, a RAM 2c, and the like. Various functions of the ECU 2 are implemented by the CPU 2a executing a program stored in a non-transitory tangible storage medium. In the present embodiment, the ROM 2b corresponds to a non-transitory tangible storage medium storing programs. Further, by executing this program, a method corresponding to the program is executed. Note that partial or all of the functions executed by the CPU 2a may be implemented by hardware such as one or more ICs. The ECU 2 may include one microcomputer or multiple microcomputers.

The multiple ECUs 3, the multiple ECUs 4, and the vehicle exterior communication device 5 include one or more microcomputers having a CPU, ROM, RAM, and the like, similarly to the ECU 2.

Each of the multiple ECUs 3 is installed for each domain divided by the function in the vehicle, and mainly controls the multiple ECUs 4 installed in the domain in charge. Each ECU 3 is connected to the subordinate ECU 4 via an individually provided lower layer network (for example, CAN). The CAN is an abbreviation for Controller Area Network. The ECU 3 centrally manages access privilege to subordinate ECUs 4 and authenticates users. The domain includes, for example, state recognition, a powertrain, a body, a chassis, a cockpit, and the like.

The ECUs 4 connected to the ECU 3 belonging to the state recognition domain include, for example, an ECU 4 that controls the camera 8, an ECU 4 that controls the GPS receiver 9, and an ECU 4 that controls a radar. The camera 8 is installed at at least one of a position close to the front, rear, and left and right of the vehicle, and captures the outside of the vehicle. The ECU 4 that controls the GPS receiver 9 calculates the current position of the vehicle based on the GPS signal received by the GPS receiver 9.

The ECUs 4 connected to the ECU 3 belonging to the powertrain domain include, for example, an ECU 4 that controls an engine, an ECU 4 that controls a motor, an ECU 4 that controls a battery, and the like.

The ECUs 4 connected to the ECU 3 belonging to the body domain include, for example, an ECU 4 that controls an air conditioner and an ECU 4 that controls doors.

The ECUs 4 connected to the ECU 3 belonging to the chassis domain include, for example, an ECU 4 that controls the brakes and an ECU 4 that controls the steering.

The ECUs 4 connected to the ECU 3 belonging to the cockpit include, for example, an ECU 4 that controls the display of meters and navigation, and an ECU 4 that controls input devices operated by vehicle occupants.

The vehicle exterior communication device 5 performs data communication with the cloud server 200 and the mobile terminal 300 via a wide area wireless communication network.

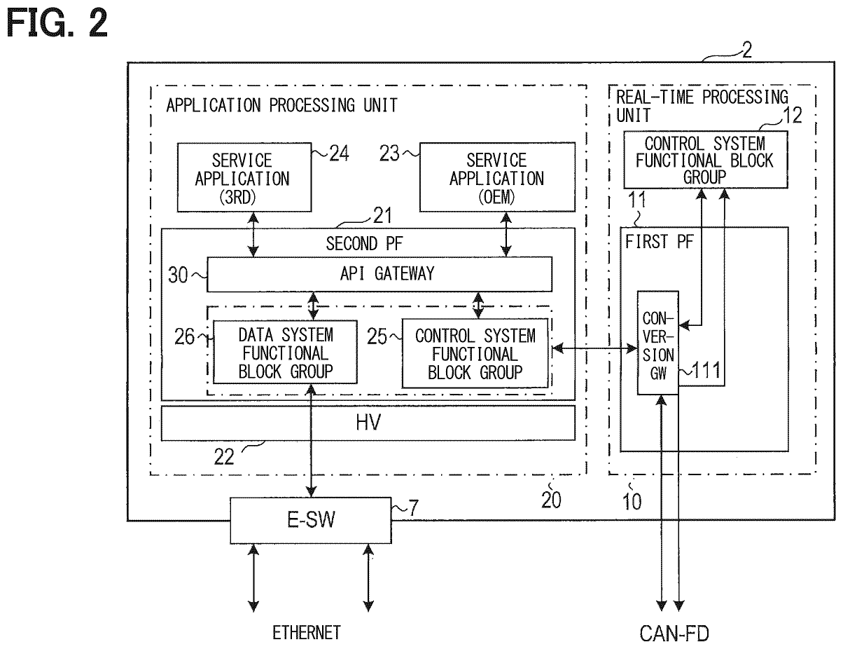

The vehicle interior communication network 6 includes CAN FD and Ethernet. The Ethernet is a registered trademark. The CAN FD is an abbreviation for CAN with Flexible Data Rate. The CAN FD connects the ECU 2 to each of the ECUs 3 and the vehicle exterior communication device 5 via a bus. The Ethernet connects the ECU 2 to each ECU 3 and the vehicle exterior communication device 5 individually. The ECU 2 is provided with an Ethernet switch 7 for switching the Ethernet to be used, as shown in FIG. 2.

The cloud server 200 is a computer including a database, generates an API authorization policy 311 described later, and stores the API authorization policy 311. Further, the cloud server 200 stores service applications (i.e., programs) created by multiple service providers. The service provider may be a supplier, an original equipment manufacturer (hereinafter referred to as OEM), a third party, or the like. The OEM is the vehicle manufacturer that produced the vehicle. The third party is any party other than a vehicle owner and an OEM. The third party is, for example, a data utilization provider that provides services using data collected from vehicles.

The service user downloads the service application created by a contracted service provider to one of the ECUs 2, 3, and 4. The service user receives a service from a service provider by any one of the ECUs 2, 3, and 4 executing a service application. The service user is a vehicle user, a vehicle owner, an operation manager, or the like. Services provided by the service provider include fleet services, traffic congestion prediction services, theft prevention services, and the like.

The mobile terminal 300 includes a smartphone, a tablet terminal, a smart watch, a PC, and the like. When any one of the ECUs 2, 3, and 4 executes a service application, the service user receives information such as execution results via the mobile terminal 300. In another embodiment, the mobile terminal 300 may be excluded from the mobility service provision system 1.

### (1-2. Configuration of In-Vehicle System)

Software installed in the ECU 2, the multiple ECUs 3, the multiple ECUs 4, and the vehicle exterior communication device 5 is constructed in accordance with an AUTomotive Open System ARchitecture (hereinafter referred to as AUTOSAR). The AUTOSAR is, for example, an architecture for automated driving. The AUTOSAR provides not only communication between software components (hereinafter referred to as SW-C) provided to implement various applications, but also functions related to connection to the cloud and security. The SW-C is parted software to implement a certain function. Note that the software of the mobility service provision system 1 does not necessarily need to be built along AUTOSAR.

The ECU 2, the multiple ECUs 3, the multiple ECUs 4, and the vehicle exterior communication device 5 are provided with a platform. The platform provides an environment for running SW-C written in a hardware-independent format.

The platform includes a runtime environment (hereinafter, RTE) and base software (hereinafter, BSW). The RTE is the interface between SW-Cs and between SW-C and BSW. The BSW is the hierarchy connecting hardware and SW-C, including operating systems (hereinafter referred to as OS), drivers, middleware, etc. The functions of the BSW are divided into small modules and the functions of each module are provided to the SW-C via a vehicle API.

A functional configuration of the ECU 2 will be described with reference to FIG. 2. The ECU 2 includes a real-time processing unit 10 and an application processing unit 20. When the ECU 2 includes multiple CPUs 2a, the real-time processing unit 10 and the application processing unit 20 may be implemented by processes executed by the same CPU 2a. The real-time processing unit 10 and the application processing unit 20 may be implemented by the processes executed by the two different CPUs 2a, respectively.

The real-time processing unit 10 cooperates with the multiple ECUs 3, the multiple ECUs 4, and the vehicle exterior communication device 5 via the CAN FD to execute vehicle control and the like that requires real-time performance. The application processing unit 20 cooperates with the multiple ECUs 3, the multiple ECUs 4, and the vehicle exterior communication device 5 via Ethernet to execute various service applications (for example, entertainment applications) that require high processing performance.

The application processing unit 20 transmits instructions based on processes of various service applications to the real-time processing unit 10. The real-time processing unit 10 transmits information collected from the multiple ECUs 3, the multiple ECUs 4, and the vehicle exterior communication device 5 to the application processing unit 20 via the CAN FD. The real-time processing unit 10 and the application processing unit 20 cooperate with each other to implement various functions.

The real-time processing unit 10 includes a first platform (hereinafter referred to as PF) 11. The application processing unit 20 includes a second PF 21.

The real-time processing unit 10 includes a control system functional block group 12. The control system functional block group 12 is a collection of software modules operating on the first PF 11. Each software module is configured by one or more SW-Cs, receives and processes requests from clients, and returns results.

The control system functional block group 12 includes a vehicle API that receives instructions related to the motion of the vehicle. The control system functional block group 12 is a software module for controlling commands accepted by the vehicle API to implement consistent vehicle control. The control system functional block group 12 outputs various instructions to the multiple ECUs 3, the multiple ECUs 4, and the vehicle exterior communication device 5 via the CAN FD. The multiple ECUs 3, the multiple ECUs 4, and the vehicle exterior communication device 5 receive various instructions and execute them.

The first PF 11 includes a conversion gateway 111. The conversion gateway 111 converts a CAN FD format communication frame received by the real-time processing unit 10 into Ethernet format communication frame, and provides it to the application processing unit 20. In addition, the conversion gateway 111 converts the communication frame in the Ethernet format provided by the application processing unit 20 into a CAN FD format communication frame.

The application processing unit 20 includes a hypervisor 22, and executes software on multiple virtual machines. In another embodiment, the hypervisor 22 may be excluded from the application processing unit 20.

The application processing unit 20 includes service applications 23 and 24. The service applications 23 and 24 are a collection of applications operating on the second PF 21, and provide a predetermined service for each application.

The service application 23 is a collection of applications provided by an OEM. Each service application 23 includes one or more SW-Cs. Further, the service application 23 may include applications developed by the OEM itself and applications developed by other vendors.

The service application 24 is a collection of applications (hereinafter referred to as third-party applications) provided by a third party. Each service application 24 includes one or more SW-Cs.

The second PF 21 includes a control system functional block group 25, a data system functional block group 26, and an API gateway 30.

The control system functional block group 25 is a set of software modules equipped with a vehicle API for accepting requests related to vehicle control from the service applications 23, 24. The control system functional block group 25 converts the vehicle API access request that is expressed in a vehicle-independent format and from the service applications 23, 24 into a vehicle API access request expressed in a vehicle-dependent format and provides it to the real-time processing unit 10. The control system functional block group 25 includes a motion system vehicle API for controlling motion of the vehicle and a non-motion system vehicle API other than the motion system vehicle API. The vehicle API is an API for using vehicle functions or vehicle data.

The motion system vehicle API transfers the accepted access request to the control system functional block group 12. The control system functional block group 12 transfers the access request to any of the multiple ECUs 3, the multiple ECUs 4, and the vehicle exterior communication device 5 corresponding to the access request via the vehicle interior communication network 6 such as the CAN FD. The non-motion type vehicle API transfers the received access request to the multiple ECUs 3, the multiple ECUs 4, and the vehicle exterior communication device 5 that support the access request via the vehicle interior communication network 6 such as CAN FD.

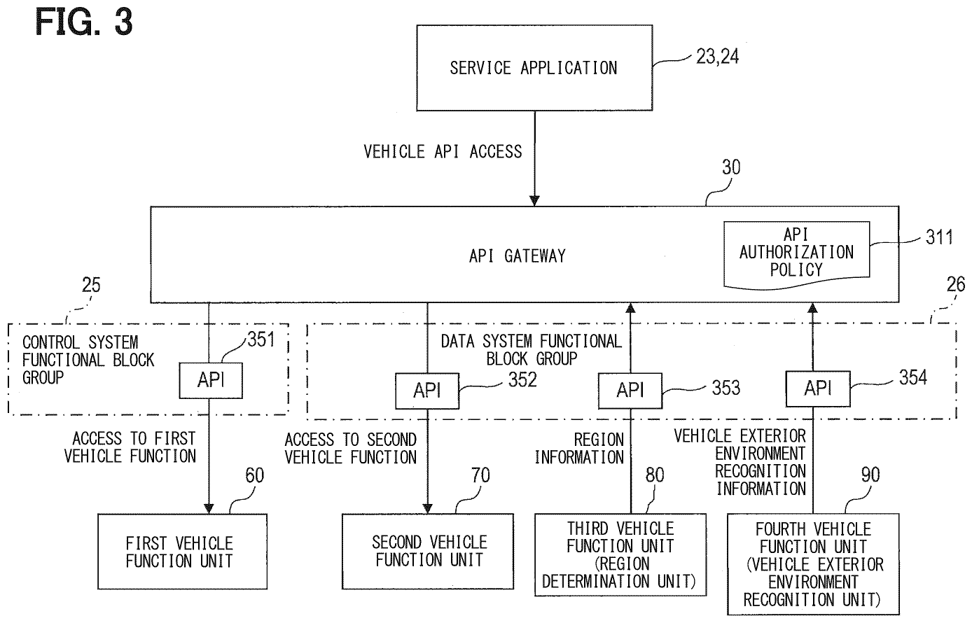

For example, as shown in FIG. 3, the control system functional block group 25 includes a non-motion type vehicle API 351, and one of the multiple ECUs 3 includes a first vehicle function unit 60. The vehicle API 351 accepts access requests to use the first vehicle function unit 60 from the service applications 23 and 24 via the API gateway 30. The access request includes an API-ID. The API-ID is information that uniquely identifies a process ID of the service application 23, 24 (hereinafter, use source application) that is the source of use and a vehicle API (hereinafter, use destination API) that is the destination of use. The vehicle API 351 transfers the accepted access request to the ECU 3 including the first vehicle function unit 60.

The data system functional block group 26 is a collection of software modules equipped with a vehicle API for handling vehicle data acquired and accumulated via the real-time processing unit 10. The data system functional block group 26 abstracts and accumulates vehicle data expressed in a vehicle-dependent format supplied from the real-time processing unit 10 into vehicle data in a vehicle-independent format.

The data system functional block group 26 may have a vehicle API that provides a function to transmit designated vehicle data to the ECU 3 or the like via the vehicle interior communication network 6 such as the Ethernet. In particular, when the data system functional block group 26 transmits vehicle data to the vehicle exterior communication device 5, the vehicle exterior communication device 5 may upload the received vehicle data to the cloud server 200. In addition, the data system functional block group 26 may have a vehicle API that provides a function for acquiring data from the cloud server 200.

For example, as shown in FIG. 3, a data system functional block group 27 includes vehicle APIs 352, 353, and 354. One of the multiple ECUs 3 includes a second vehicle function unit 70. One of the multiple ECUs 4 includes a third vehicle function unit 80, and another of the multiple ECUs 4 includes a fourth vehicle function unit 90. In the present embodiment, the third vehicle function unit 80 provides a function of determining the country or region where the vehicle is located based on the current position of the vehicle. Furthermore, the third vehicle function unit 80 provides a function of acquiring movement information indicating that the vehicle has moved from the first region to the second region based on the determined region. The second region is different from the first region. The fourth vehicle function unit 90 provides a function of recognizing the vehicle exterior environment based on data acquired by vehicle sensors such as the camera 8 and radar. The vehicle exterior environment is, for example, a display object indicating information about the region in which the vehicle is traveling, and includes road markings, traffic signs, billboards, and the like around the vehicle. The fourth vehicle function unit 90 provides a function of recognizing the vehicle exterior environment based on images and the like acquired by the vehicle sensor.

The vehicle API 352 accepts, from the service applications 23 and 24, access requests to provide vehicle data to the second vehicle function unit 70 via the API gateway 30. The vehicle API 352 provides the vehicle data received from the service applications 23, 24 to the ECU 3 including the second vehicle function unit 70 via the API gateway 30 in response to the accepted access request.

The vehicle API 353 accepts access requests to acquire regional information and/or movement information from the service applications 23 and 24 via the API gateway 30. The vehicle API 353 forwards the received access request to the ECU 4 including the third vehicle function unit 80, and receives the region information and/or movement information designated by the service applications 23 and 24 from the third vehicle function unit 80. The vehicle API 353 provides the received regional information and/or movement information to the service applications 23, 24 via the API gateway 30.

The vehicle API 354 accepts an access request to acquire recognition information of the vehicle exterior environment from the service applications 23 and 24 via the API gateway 30. The vehicle API 353 transfers the received access request to the ECU 4 including the fourth vehicle function unit 90, and receives recognition information of the vehicle exterior environment specified by the service applications 23 and 24 from the fourth vehicle function unit 90. The vehicle API 353 provides the received recognition information of the vehicle exterior environment to the service applications 23 and 24 via the API gateway 30.

When the ECU 2 communicates with the multiple ECUs 3, the multiple ECUs 4, and the vehicle exterior communication device 5 via the control system functional block group 25, not only the CAN FD but also Ethernet and other communication means may be used. Further, when the ECU 2 communicates with the multiple ECUs 3, the multiple ECUs 4, and the vehicle exterior communication device 5 via the data system functional block group 26, not only Ethernet but also CAN FD and other communication means may be used.

The API gateway 30 is configured by utilizing functions of a virtual function bus (hereinafter referred to as VFB). The VFB is middleware that enables communication between SW-Cs and between SW-C and BSW without awareness of hardware or communication protocol, and also called software bus.

The API gateway 30 controls whether to accept access requests, transmit access requests determined to be acceptable, and transmit and receive data between the service applications 23 and 24 and the vehicles APIs 351, 352, 353, and 354.

Communication between SW-Cs is performed between applications belonging to the service applications 23 and 24. That is, the communication between SW-Cs corresponds to access from SW-Cs to APIs provided by other SW-Cs.

The communication between SW-C and BSW is performed between the service applications 23 and 24, and the control system functional block group 25 and the data system functional block group 26. That is, the communication between SW-C and BSW corresponds to access from the SW-C to the vehicle API. Hereinafter, the SW-C and the service application are assumed to correspond to each other on a one-to-one basis.

In the present embodiment, the ECU 2 includes the real-time processing unit 10 and the application processing unit 20. However, in another embodiment, the ECU 2 may not include the real-time processing unit 10 or the application processing unit 20.

In the present embodiment, the ECU 2 includes the service applications 23, 24, the control system functional block group 25, the data system functional block group 26, and the API gateway 30. However, in another embodiment, in addition to or instead of the ECU 2, at least one of the multiple ECUs 3, the multiple ECUs 4, or the vehicle exterior communication device 5 may include the service applications 23, 24, the control system functional block group 25, the data system functional block group 26, and the API gateway 30 in a centralized or distributed manner.

Each of the first to fourth vehicle functional units 60 to 90 may be mounted on one of the ECU 2, the multiple ECUs 3, the multiple ECUs 4, or the vehicle exterior communication device 5, or may be distributed among the plurality of them. In another embodiment, the in-vehicle system 100 may have three or fewer functional units, or five or more functional units.

### (1-3. API Gateway)

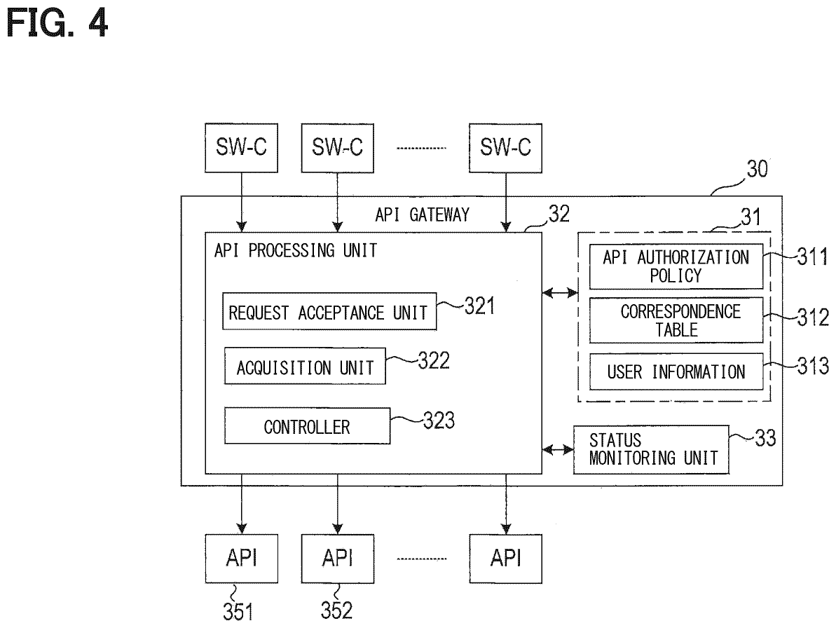

Details of the API gateway 30 will be described with reference to FIG. 4. The API gateway 30 includes an information storage 31, an API processing unit 32, and a status monitoring unit 33.

The information storage 31 stores the API authorization policy 311, a correspondence table 312, and user information 313. The correspondence table 312 is stored in the RAM 2c, and the API authorization policy 311 and the user information 313 are stored in the ROM 2b. However, the API authorization policy 311 and the user information 313 may be stored in the non-volatile RAM 2c.

The API authorization policy 311 is a collection of information for determining whether there is the access privilege from the service application 23 or 24 to the vehicle API. The API authorization policy 311 is downloaded from the cloud server 200 and stored in the information storage 31. The API authorization policy 311 may be downloaded and updated based on instructions from the cloud server 200.

The correspondence table 312 includes first correspondence information and second correspondence information. The first correspondence information associates the process ID dynamically assigned to a process with a unique application ID of a service application executed in the process. The process is an execution unit of the program in the OS. The second correspondence information associates the unique API-ID of each of the multiple vehicle APIs with the process ID of a process assigned to a service application that uses the vehicle function or vehicle data via the vehicle API. The correspondence table 312 is generated by the OS when the system starts and a process for each service application is generated.

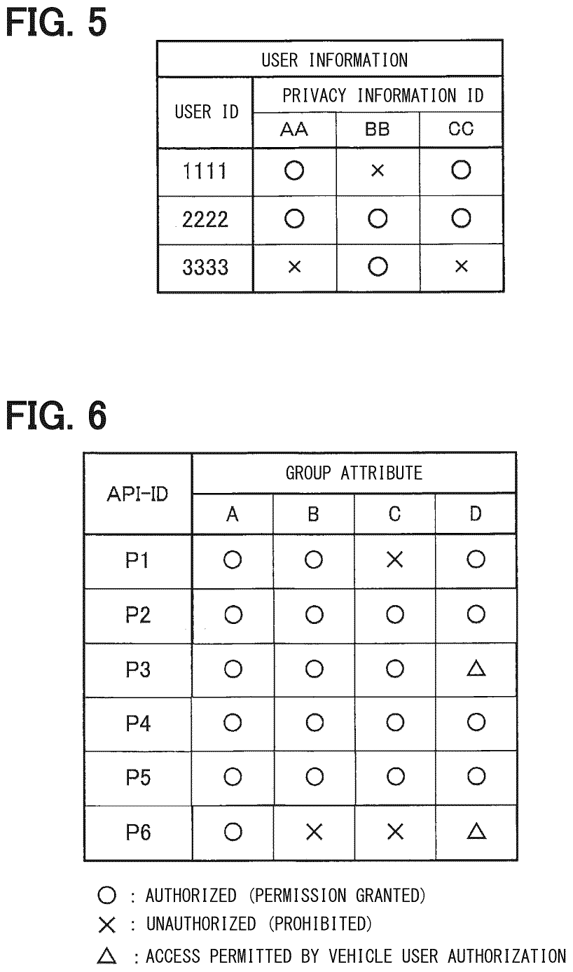

The user information 313 is arbitrarily set by the vehicle user. The vehicle user may include a passenger of the vehicle in addition to the driver. The user information 313 is referenced when a controller 323, which will be described later, uses the API authorization policy 311 to determine whether there is access privilege. For example, as shown in FIG. 5, the user information 313 specifies whether to permit access requests to privacy information from the service applications 23 and 24 for each vehicle user. The vehicle user is identified by a user ID, and the privacy information is identified by a privacy ID. The user information 313 may include contact information for the vehicle user.

The API processing unit 32 has the functions of a request acceptance unit 321, an acquisition unit 322, and the controller 323. The request acceptance unit 321 accepts access requests to the vehicle APIs 351 to 354 respectively corresponding to the first to fourth vehicle function units 60 to 90. The acquisition unit 322 acquires movement information acquired by the third vehicle function unit 80. That is, the acquisition unit 322 acquires the movement information indicating that the vehicle has moved from the first region to the second region. The controller 323 determines whether to permit or prohibit the access request based on the API authorization policy 311. Furthermore, the controller 323 changes the control of the access request when the movement information is acquired by the acquisition unit 322. In another embodiment, the acquisition unit 322 may acquire the region determined by the third vehicle function unit 80. Then, the acquisition unit 322 may acquire movement information indicating that the vehicle has moved from the first region to the second region based on the acquired region.

The laws and regulations concerning vehicles and vehicle users differ from region to region. For example, some countries prohibit a predetermined operation of the driver while driving, while others do not. In some countries, predetermined information is subject to privacy protection, and in other countries, it is not subject to privacy protection. Furthermore, in one country, there are areas where a predetermined function of the vehicle is restricted, and there are areas where the predetermined function is not restricted.

The API authorization policy 311 defines whether each of the multiple vehicle APIs has access privilege for each region. For example, the API authorization policy 311 defines that, in regions where the predetermined information corresponds to privacy information, the access privilege to the vehicle API, which provides the specified information to the service applications 23 and 24, is “unauthorized”. The API authorization policy 311 defines that, in regions where the predetermined information does not correspond to privacy information, the access privilege to the vehicle API, which provides the specified information to the service applications 23 and 24, is “authorized”. For example, the API authorization policy 311 defines the access privilege to the vehicle API, which provides the predetermined function to the service applications 23 and 24, as “unauthorized” in regions where the predetermined function is subject to regulation. The API authorization policy 311 defines the access privilege to the vehicle API, which provides the predetermined function to the service applications 23 and 24, as “authorized” in regions where the predetermined function is not subject to regulation.

Based on the country or region information acquired from the third vehicle function unit 80 and the recognition information of the vehicle exterior environment acquired from the fourth vehicle function unit 90, the controller 323 refers to the first policy corresponding to the first region where the vehicle is located in the API authorization policy 311, and controls the access request for each vehicle API. That is, the controller 323 permits or prohibits an access request for each vehicle API. Further, when the movement information is acquired by the acquisition unit 322, the controller 323 refers to, in the API authorization policy 311, a second policy corresponding to the second region where the vehicle is located to control the access request for each vehicle API. Furthermore, the controller 323 acquires vehicle exterior information indicated by traffic signs, billboards, and road markings of the region where the vehicle is positioned based on the recognition information of the vehicle exterior environment, and determines whether there are regional regulations based on the vehicle exterior information. Details of the API authorization policy 311 will be described later.

When the controller 323 permits the access request of the first vehicle function unit 60 to the vehicle API 351, the service applications 23 and 24 can use the functions of the first vehicle function unit 60 via the vehicle API 351. When the controller 323 prohibits the access request of the second vehicle function unit 70 to the vehicle API 352, the service applications 23 and 24 cannot access the functions of the second vehicle function unit 70 via the vehicle API 352.

When the controller 323 accepts an access request to the vehicle API, it identifies the application ID of the use source application based on the process ID indicated by the access request and the correspondence table 312. The controller 323 executes an access restriction process based on the identified application ID, the API-ID of the use destination API indicated by the access request, and the API authorization policy 311, and controls access requests to the vehicle APIs 351 to 352. The access restriction process will be described in detail later.

The status monitoring unit 33 monitors the access status from each service application to each of the multiple vehicle APIs 351 to 354, and generates status information indicating the access status. The status information is generated, for example, by tallying up the number of accesses to each vehicle API 351 to 354, the amount of data handled in processing, and the like for each use source application.

### 2. API Authorization Policy

The cloud server 200 includes a microcomputer having a CPU, ROM, RAM, and the like, and a database. Various functions of the cloud server 200 are implemented by the CPU executing a program stored in a non-transitory tangible storage medium. The cloud server 200 executes an authorization policy generation process to generate the API authorization policy 311, and stores the generated API authorization policy 311 in the database.

The cloud server 200 generates the API authorization policy 311 that specifies whether there is the access privilege from the service applications 23, 24 to each vehicle API for each region. As described above, laws and regulations regarding vehicles and users differ depending on the community including multiple countries or the country. Furthermore, regulations differ depending on the state, town, and area in one country. The cloud server 200 generates the API authorization policy 311 that specifies whether there is the access privilege to each vehicle API for each region so as to comply with laws and regulations. In the present embodiment, the region may be a community including multiple countries, a country, a state, a town, or an area within the country. In this way, the API authorization policy 311 defines whether access privilege is granted for each region and for each service application.

Furthermore, the cloud server 200 may prepare multiple viewpoint-specific policies that are generated from different viewpoints for each of S, F, and O, respectively. The viewpoint-specific policies may be generated by the cloud server 200, or those generated outside the cloud server 200 may be collected by the cloud server 200. The S.F.O.P. is viewpoints defined as a security protection asset. The S is an abbreviation for Safety, and means access restrictions on vehicle APIs that affect the safety. The F is an abbreviation for Financial, and means access restrictions on vehicle APIs that affects the corporate or personal assets. The “O” is an abbreviation for “Operational” and means access restrictions on vehicle API that affects the operational performance of the vehicle. The P is an abbreviation for Privacy, and means access restrictions on vehicle APIs that affects the privacy information. The viewpoint-specific policy does not necessarily need to be prepared for all viewpoints of the S.F.O.P. Further, multiple viewpoint-specific policies may be prepared for one viewpoint.

The viewpoint-specific policy includes a static viewpoint-specific policy and a dynamic viewpoint-specific policy. The static viewpoint-specific policy is generated by focusing on the static viewpoints of the service applications 23 and 24. The dynamic viewpoint-specific policy is generated by focusing on the dynamic viewpoints of the service applications 23 and 24.

The static viewpoint of the service applications 23 and 24 is information about features that do not change depending on the usage environment, usage conditions, and the like of the service applications 23 and 24. The static viewpoint of the service applications 23 and 24 includes, for example, information representing the safety of processes executed by the service applications 23, 24, information representing the providers of the service applications 23, 24, and the like. The dynamic viewpoint of the service applications 23 and 24 is information about features that change depending on the usage environment, usage conditions, and the like of the service applications 23 and 24. The dynamic viewpoint of the service applications 23 and 24 includes, for example, restrictions imposed by the billing contract of the provider of the service applications 23, 24, information arbitrarily set by the vehicle user, and the like.

The cloud server 200 may generate the region-specific API authorization policy 311 for each of multiple viewpoints, or may generate the API authorization policy 311 for each viewpoint for each of multiple regions.

### (2-1. Regional Authorization Policy)

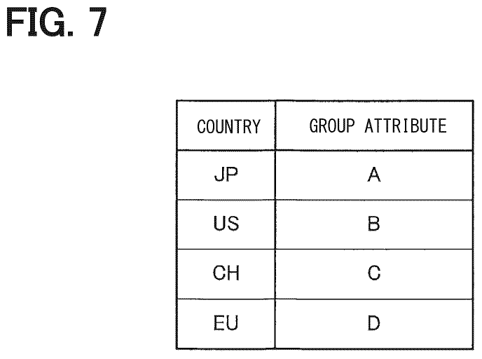

Regional authorization policies included in the API authorization policy 311 will be described with reference to FIGS. 6 and 7. The table shown in FIG. 7 associates the five countries with group attributes A to D classified based on the laws and regulations of each country. The regional authorization policy table shown in FIG. 6 represents whether each country identified by the group attribute has access privilege to each of the use destinations API_P1 to P6 identified by the API-ID. The circle mark indicates access privilege, and the cross mark indicates no access privilege. The triangle mark indicates that the vehicle user has access privilege when the vehicle user permits it. That is, the triangle mark indicates that there is no access privilege at the initial setting, and indicates that the access privilege is changed from the “unauthorized” state to the “authorized” state or the access privilege is maintained at the “unauthorized” state based on the intention of the vehicle user.

Whether to permit access to the privacy information from the service applications 23 and 24, and to what extent, depends on the intention of the vehicle user. Accordingly, the controller 323 prioritizes the intention of the vehicle user for setting whether there is the access privilege to the vehicle API 351 to 354 providing the privacy information. Even in a case where the controller 323 prohibits access to the vehicle APIs 351 to 354 that provide the predetermined privacy information based on the initial setting in the region where the vehicle is located, when the vehicle user permits access to the predetermined privacy information, the controller 323 permits access from the service applications 23, 24 to the vehicle APIs 351 to 354.

Furthermore, the authorization policy for each region may define the priority of access requests when multiple service applications 23 and 24 access the vehicle APIs 351 to 354. The priority is defined for a combination of the types of service applications 23 and 24 and the types of vehicle APIs 351 to 354. Alternatively, the authorization policy for each region may define the priority for each of the service applications 23 and 24 using the vehicle API for each of the vehicle APIs 351 to 354. The priority may be defined by a relative value or an absolute value among the service applications 23 and 24. For example, the priority may be defined by five values of 1, 2, 3, 4, and 5, and the smaller the value, the higher the priority.

The service applications 23 and 24 provide different services to the vehicle user. For example, the regional authorization policy may be defined so that in region A, the priority of access requests from the first service application to the vehicle API_P1 is higher than the priority of access requests from the second service application to the vehicle API_P2. That is, the regional authorization policy may prioritize the process of the first service application using the vehicle API_P1 over the process of the second service application using the vehicle API_P2. Hereinafter, examples of regional authorization policies will be described.

### (2-1-1. First Case)

In some countries, during the driving of the vehicle, the operation of the mobile terminal 300 by the driver (for example, a call operation, an email operation, a search operation, or the like) is prohibited by laws. The regional authorization policy is used, for such countries, to restrict to the minimum necessary level, the access to the vehicle API for information notification from the service applications 23 and 24 to the mobile terminal 300 of the driver during driving of the vehicle. For example, the regional authorization policy specifies that access from the service applications 23 and 24 to the vehicle API that provides the function related to S in the S.F.O.P is permitted, and access to the vehicle API that provides the function related to F.O.P is prohibited.

For example, the vehicle API that provides the function related to S is an API that provides a function of providing notification indicating an abnormality in a vehicle system or a vehicle function (for example, a brake function, a steering function, or the like). The vehicle API that provides the function related to P includes, for example, an API that offers a notification function indicating that the service applications 23 and 24 have accessed privacy information stored in the in-vehicle system 100. The vehicle API that provides the function related to O includes, for example, an API that offers a notification function indicating the occurrence of traffic congestion around the vehicle. The vehicle API that provides the function related to F includes, for example, an API that offers a notification function to inform the vehicle user of a billing request when the service applications 23 and 24 add or continue services or functions.

### (2-1-2. Second Case)

The definition (or scope) of personal information differs depending on the country. For example, in some countries, traveling history information alone constitute personal information, and in other countries, the traveling history information alone does not constitute personal information. Further, in some countries, hands-free telephone directory information alone constitutes personal information, and in other countries, the hands-free telephone directory information alone does not constitute personal information. Further, in some countries, history information of outgoing and incoming calls alone constitutes personal information, and in other countries, the history information of outgoing and incoming calls alone does not constitute personal information.

The regional authorization policy is defined so as to prohibit access to the vehicle API that provides traveling history information from the service applications 23 and 24, in countries where the traveling history information alone constitutes personal information, when permission from the vehicle user is not given. The regional authorization policy is defined so as to permit access to the vehicle API that provides traveling history information from the service applications 23 and 24, in countries where the traveling history information alone does not constitute personal information, even when permission from the vehicle user is not given.

The regional authorization policy is defined so as to prohibit access to the vehicle API that provides telephone directory information from the service applications 23 and 24, in countries where the telephone directory information alone constitutes personal information, when permission from the vehicle user is not given. The regional authorization policy is defined so as to permit access to the vehicle API that provides telephone directory information from the service applications 23 and 24, in countries where the telephone directory information alone does not constitute personal information, even when permission from the vehicle user is not given.

The regional authorization policy is defined so as to prohibit access to the vehicle API that provides history information from the service applications 23 and 24, in countries where the history information alone constitutes personal information, when permission from the vehicle user is not given. The regional authorization policy is defined so as to permit access to the vehicle API that provides history information from the service applications 23 and 24, in countries where the history information alone does not constitute personal information, even when permission from the vehicle user is not given.

### (2-1-3. Third Case)

In one country, some areas restrict exhaust gas, while other areas do not restrict exhaust gas. The regional authorization policy is defined so as to prohibit access from the service applications 23 and 24 to the vehicle API that provides a function for changing a drive mode, in areas where exhaust gas is restricted. Here, the change of the prohibited drive mode is a change from a drive mode that suppresses exhaust gas to a different drive mode. The regional authorization policy is defined so as to permit access to the vehicle API that provides the function of changing the drive mode for areas in which exhaust gas is not restricted.

### (2-1-4. Fourth Case)

In some countries, pedestrians are prioritized over vehicles at intersections, and in other countries, vehicles are prioritized over pedestrians. The regional authorization policy is defined so that the first access is prioritized over the second access in a country where the pedestrian is prioritized over the vehicle. The first access is from a first service application to a vehicle API that provides a function of performing notification regarding pedestrians in the periphery of the vehicle. The second access is from a second service application to a vehicle API that provides a function of performing notification regarding other vehicles in the periphery of the vehicle.

### (2-2. Authorization Policy Related to Safety)

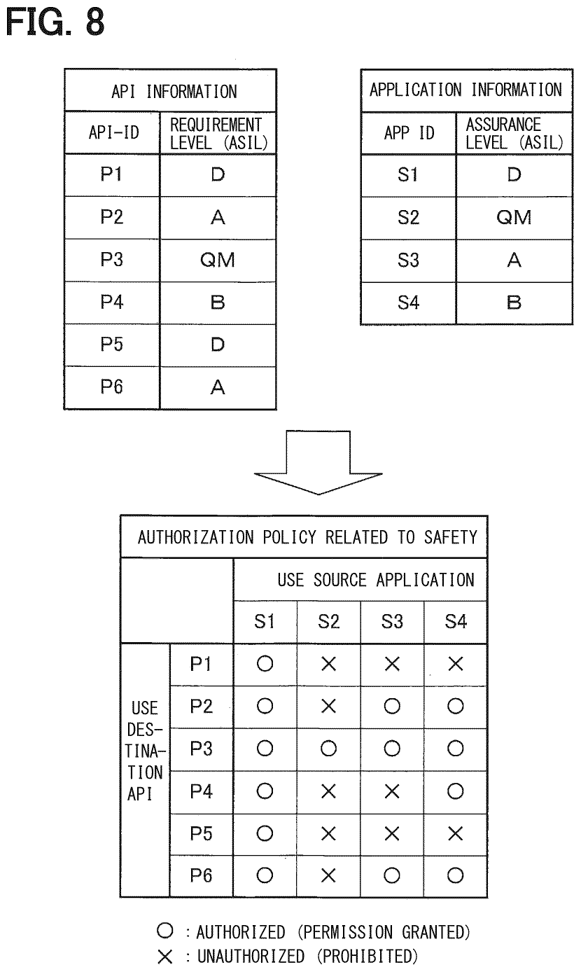

An authorization policy related to the safety in the API authorization policy 311 will be described with reference to FIG. 8. The safety-related authorization policy is an example of a static viewpoint-specific policy classified as an S attribute.

Service applications (hereinafter referred to as safety system applications) 23, 24 that include processes related to vehicle safety are assigned an assurance level. The assurance level indicates the reliability of the safety of the process included in the safety system application. The vehicle API (hereinafter referred to as safety system API) included in the safety system application is assigned a requirement level. The requirement level indicates the safety reliability required for the service application that is the use source and requests access to the safety system API.

The assurance level and the requirement level are, for example, Automotive Safety Integrity Level (hereinafter referred to as ASIL). The ASIL is a risk classification system defined by ISO 26262 standard for functional safety of vehicles on the road. The ASIL is determined by three types of parameters: probability of exposure, controllability, and severity, and is expressed on a scale of A to D. The A is the lowest level, and the D is the highest level. No requirement level is assigned to the non-safety system API, and the fact that no requirement level is assigned is represented by QM. That is, the assurance level and the requirement level are essentially expressed on a scale of QM, A to D, with QM being the lowest level. The assurance level and the requirement level do not necessarily need to use the ASIL, but should be an index indicating the reliability of safety defined to have multiple levels. Therefore, the assurance level and the requirement level do not need to be four indices of A to D, but three indices or less, or five indices or more.

A safety-related authorization policy table shown in FIG. 8 is generated based on application information and API information. The application information associates an application ID with the assurance level assigned to the service applications 23 and 24 identified by the application ID. The API information associates an API-ID with the requirement level assigned to the vehicle API identified by the API-ID.

The safety-related authorization policy table shown in FIG. 8 represents whether there is access privilege from each use source application S1 to S4 identified by the application ID to the use destination API_P1 to P6 identified by the API-ID. When the assurance level of the service applications 23 and 24 is equal to or higher than the requirement level of the vehicle APIs 351 to 354, the service applications 23 and 24 have the access privilege to the vehicle API from 351 to 354. When the assurance level of the service applications 23 and 24 is lower than the requirement level of the vehicle APIs 351 to 354, the service applications 23 and 24 do not have access privilege to the vehicle APIs 351 to 354.

### (2-3. Authorization Policy Related to Corporate Asset)

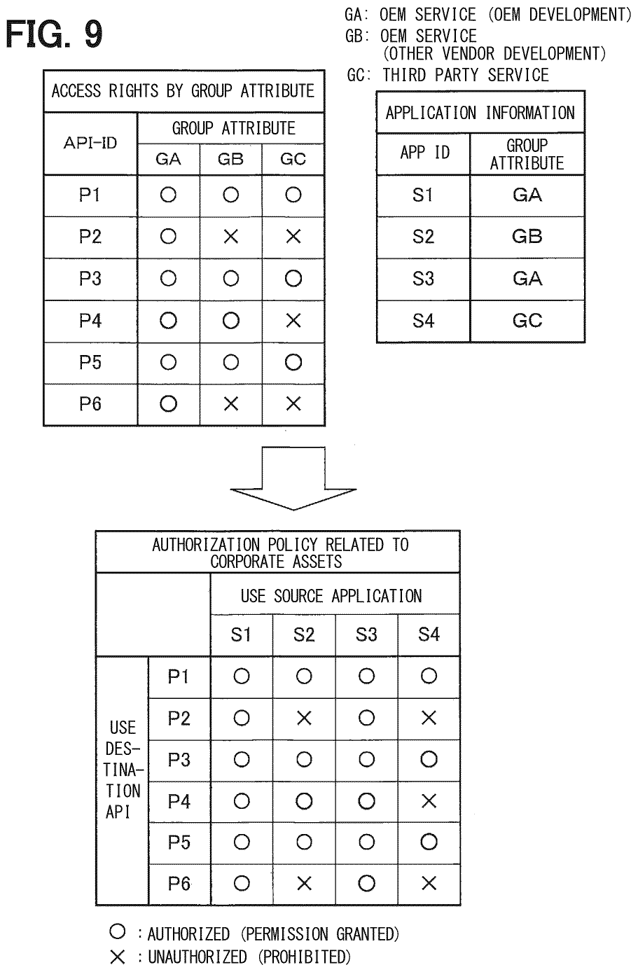

An authorization policy related to corporate assets in the API authorization policy 311 will be described with reference to FIG. 9. The authorization policy related to corporate assets is an example of the static viewpoint-specific policy classified as the F attribute.

Group attributes are assigned to the service applications 23 and 24 according to the provider. The group attributes include GA, GB, and GC. The GA represents an OEM application developed in-house. GB represents an OEM application developed by another vendor. The GC represents a third-party application developed by a third party.

The authorization policy table related to corporate assets shown in FIG. 9 is generated based on access information by group attributes and application information. The application information associates the application ID with the group attribute assigned to the service applications 23 and 24 identified by the application ID. The access right information by the group attribute associates an API-ID with the presence or absence of access privilege to the vehicle API identified by the API-ID for each group attribute. The reliability of the service applications 23 and 24 of the group attribute GA is higher than the reliability of the service applications 23 and 24 of the group attribute GB. The reliability of the service application of the group attribute GB is higher than the reliability of the service applications 23 and 24 of the group attribute GC. The presence or absence of access privilege from each group attribute to each vehicle API is configured based on the reliability.

The authorization policy table related to corporate assets shown in FIG. 9 indicates whether each of the use source applications S1 to S4 identified by the application ID has access privilege to each of the use destinations API_P1 to P6 identified by the API-ID.

### (2-4. Authorization Policy Related to Personal Assets)

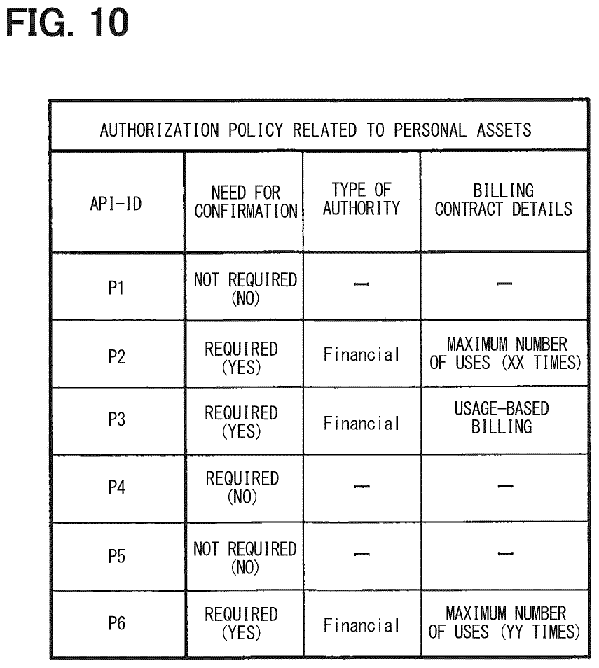

An authorization policy related to personal assets included in the API authorization policy 311 will be described with reference to FIG. 10. The personal assets-related authorization policy is an example of a dynamic viewpoint-specific policy classified into the F attribute.

The controller 323 determines whether the service applications 23, 24 have access privilege to each of the multiple vehicle APIs 351 to 354 based on the authorization policy related to personal assets and the API billing contract between the provider of the service applications 23 and 24.

The authorization policy table related to personal assets shown in FIG. 10 associates an API-ID with confirmation necessity information, privilege type information, and billing contract contents information set for the vehicle API identified by the API-ID.

The confirmation necessity information indicates whether the controller 323 needs to confirm a dynamic privilege related to the personal assets when determining the access privilege from the service applications 23 and 24 to the vehicle APIs 351 to 354. In the present embodiment, the authorization policy specifies that the dynamic authorization confirmation is required when the billing contract exists for access to vehicle APIs 351 to 354.

The privilege type information indicates which viewpoint of S.F.O.P the information corresponds to. In the “authorization policy related to personal assets”, it is set to F (i.e., Financial).

The billing contract content information is information that indicates the contents of the billing contract for the vehicle APIs 351 to 354. For example, the billing contract content information includes the upper limit number of uses of the vehicle APIs 351 to 354, limitations on usage-based billing, and the like.

### (2-5. Authorization Policy Related to Privacy)

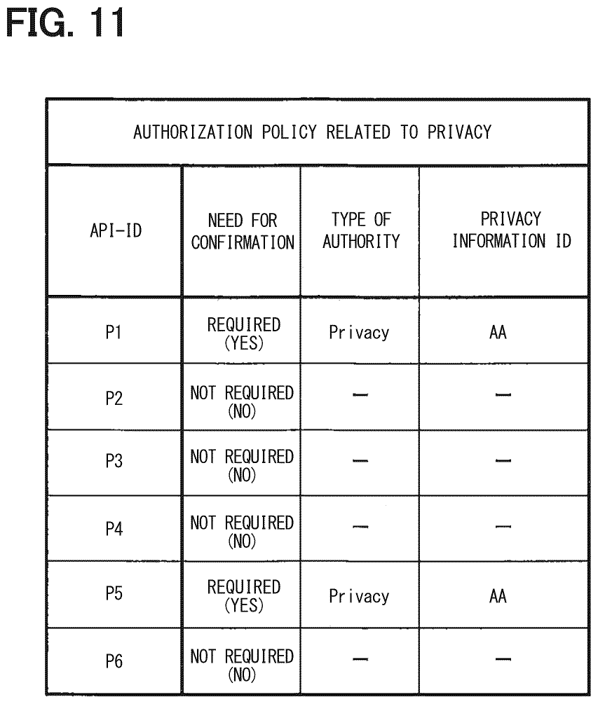

An authorization policy related to the policy in the API authorization policy 311 will be described with reference to FIG. 11. The authorization policy related to the privacy is an example of a dynamic viewpoint-specific policy classified from the P viewpoint. The privacy information relates to the privacy of the vehicle user and is stored in the vehicle.

The table of authorization policy related to the privacy as shown in FIG. 11 associates API-IDs with confirmation necessity information, privilege type information, and privacy information ID set for the vehicle API identified by the API-ID.

The confirmation necessity information indicates whether confirmation of dynamic privilege regarding privacy is required when the controller 323 determines the access privilege to the vehicle API from the service applications 23, 24. In the present embodiment, the authorization policy related to the privacy specifies that dynamic privilege confirmation is required when the service applications 23, 24 use privacy information via the vehicle APIs 351 to 354.

The privilege type information indicates which viewpoint of S.F.O.P the information corresponds to. In the “authorization policy related to privacy”, it is set to P (i.e., Privacy).

The privacy information ID indicates the ID assigned to the privacy information accessed by each of the vehicle APIs 351 to 354. The controller 323 refers to a part of the user information 313 that corresponds to the user ID and the privacy ID, and recognizes whether the vehicle user has permitted the access request to the privacy information.

### (2-6. Regional Authorization Policy for Each of Multiple Viewpoints)

The API authorization policy 311 may include a table of authorization policies for each region in all or some viewpoints of S.F.O.P. For example, the API authorization policy 311 may include a three-dimensional table that associates group attributes (i.e., regions) and use source applications with the presence or absence of access privileges of the use destination API from the safety viewpoint. In addition, from the privacy viewpoint, the API authorization policy 311 may include a three-dimensional table that associates group attributes, confirmation necessity, privilege type, and privacy information ID with the presence or absence of privilege for the use destination API.

Alternatively, the API authorization policy 311 may include an authorization policy for all or some viewpoints of S.F.O.P. for each region. For example, the API authorization policy 311 may include a table of safety-related authorization policies in region A, a table of safety-related authorization policies in region B, a table of privacy-related authorization policies in region A, and a table of privacy-related authorization policies in region B.

The cloud server 200 distributes the generated API authorization policy 311 when receiving a distribution request from the in-vehicle system 100 or when determining that the generated API authorization policy 311 should be distributed. The in-vehicle system 100 stores the API authorization policy 311 acquired from the cloud server 200 in the information storage 31 of the API gateway 30, and uses the authorization policy 311 for the access control process.

### (3. Access Control Process)

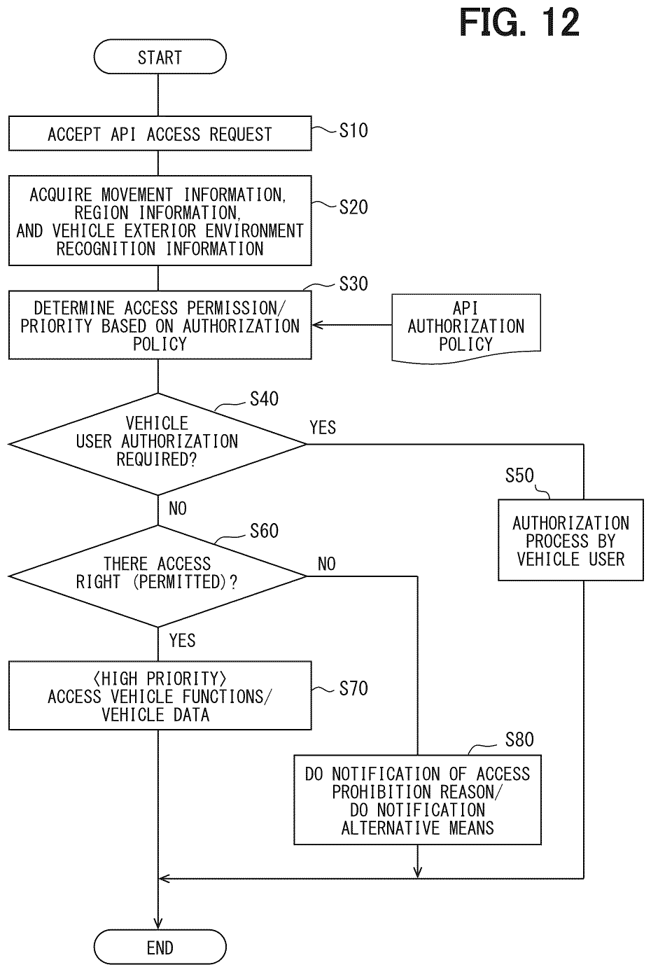

An access control process executed by the request acceptance unit 321, the acquisition unit 322, and the controller 323 will be described with reference to FIG. 12. The request acceptance unit 321, the acquisition unit 322, and the controller 323 repeatedly execute the access control process at a predetermined cycle.

In S10, the request acceptance unit 321 receives access requests from at least one of the service applications 23, 24 to one or more vehicle APIs 351 to 354.

Next, in S20, the acquisition unit 322 acquires region information and movement information from the third vehicle function unit 80, and acquires recognition information of the vehicle exterior environment from the fourth vehicle function unit 90. Then, the controller 323 recognizes the region where the vehicle is currently located and the regulations in that region based on the information acquired by the acquisition unit 322. Further, the controller 323 detects whether the vehicle has moved across the region in a period between the previous process cycle and the current process cycle.

Next, in S30, the controller 323 determines whether to grant the accepted access request based on the API authorization policy 311 according to the region and regulation recognized in S20. When the controller 323 detects that the vehicle has moved across the region in a period between the previous process cycle and the current process cycle, the controller 323 changes the referenced policy in the API authorization policy 311 from the first policy corresponding to the first region to the second policy corresponding to the second region. Further, when the controller 323 receives access requests from the multiple service applications 23 and 24, it determines the priority of the multiple access requests based on the API authorization policy 311.

Next, in S40, the controller 323 determines whether the permission of the vehicle user is necessary to permit access to the vehicle API corresponding to the received access request. That is, the controller 323 determines whether the triangle mark is set in the authorization policy table shown in FIG. 6. When the controller 323 determines that the permission of the vehicle user is necessary, the process proceeds to S50. When the controller 323 determines that the permission of the vehicle user is unnecessary, the process proceeds to S60.

In S50, the controller 323 executes an authorization process for the vehicle user's access to the vehicle APIs 351 to 354. Specifically, the controller 323 inquires whether to permit the vehicle user to access the corresponding vehicle API via the mobile terminal 300, the navigation device, or the like. When it is necessary to access the privacy information of a passenger other than the driver, the controller 323 also inquires of the passenger whether to permit access to the corresponding vehicle API. Then, the controller 323 accepts the answer from the vehicle user via the mobile terminal 300, the navigation device, or the like, and ends the process. In the current process cycle, the controller 323 determines that, for the vehicle API for which the answer of access permission has been obtained from the vehicle user, the permission by the vehicle user is unnecessary in the process of S40 from the next process cycle onwards.

In S60, the controller 323 determines whether to permit each accepted access request. The controller 323 determines to permit an access request when access from the service applications 23 and 24 to the corresponding vehicle APIs is authorized by either the API authorization policy 311 or the vehicle user. The controller 323 proceeds to S70 when it determines, for each access request, that the access request is to be permitted, and proceeds to S80 when it determines that the access request is to be prohibited.

In S70, the controller 323 accesses the vehicle functions or vehicle data provided by the vehicle API via the vehicle API corresponding to the permitted access request, and ends this process. When the controller 323 receives an access request from multiple service applications 23, 24, the controller 323 accesses vehicle functions or vehicle data provided by the vehicle API corresponding to the access request with the high priority. In this case, the controller 323 may access the vehicle functions or vehicle data provided by the vehicle API corresponding to the access request having the low priority after the process corresponding to the access request having the high priority ends, or may prohibit the access request having the low priority.

In S80, the controller 323 notifies the service applications 23, 24 that the access request has been prohibited, and notifies them of the reason why the access request has been prohibited, and ends this process. For example, the controller 323 notifies the user that the access request has been prohibited by a law or regulation of the region in which the vehicle is located. Alternatively, the controller 323 notifies the user that the priority of the access request has decreased and the access request has been prohibited in response to the movement of the vehicle from the first region to the second region.

Alternatively or in addition, the controller 323 may notify the service applications 23 and 24 that the access request has been prohibited, propose an alternative means, and end the process. Specifically, the controller 323 proposes a process using the vehicle API to which access is allowed instead of the vehicle API to which access is prohibited. For example, when access to the vehicle API that provides a function for displaying traffic congestion information on the screen of the mobile terminal 300 is prohibited, the controller 323 proposes displaying the traffic congestion information on the vehicle navigation screen.

### (4. Effects)

According to the embodiment described in detail above, the following effects are achieved.
(1) The controller 323 changes the control of the access request based on the acquisition of the vehicle movement information. Therefore, service application providers such as third parties do not need to adapt their service applications to the vehicle environment such as laws and regulations in various regions. Accordingly, it is possible to implement precise access control according to the environment of the region while reducing the burden on service application providers.
(2) The API gateway 30 has an authorization policy 311 that defines the presence or absence of access privilege for each region, and the controller 323 changes the authorization policy to be referred according to the movement of the region. Thereby, it is possible to implement access control according to the vehicle environment in various regions.
(3) The controller 323 may permit or prohibit an access request for each vehicle API. Accordingly, the in-vehicle system 100 can provide more services to the vehicle user than when permitting or prohibiting execution for each service application.
(4) The controller 323 can change the priority of access requests from each of the service applications 23 and 24 to each of the vehicle APIs 351 to 354 for each region.
(5) Even when the controller 323 prohibits access requests to vehicle APIs related to the vehicle user privacy information based on the API authorization policy 311, it can change the access request state from the prohibited state to the permitted state in response to the vehicle user permission for access requests to those vehicle APIs related to privacy information. Accordingly, the controller 323 can control the access request to the vehicle API related to the privacy information by prioritizing the intention of the vehicle user.
(6) When the controller 323 prohibits an access request to the vehicle API, the controller 323 presents an alternative means to the service applications 23, 24, so that the service applications 23, 24 can execute processes using the alternative vehicle API.
(7) When the controller 323 prohibits an access request to a vehicle API, it notifies the service applications 23 and 24 that the access request has been prohibited and also provides the reason for the prohibition. Therefore, the service applications 23 and 24 can recognize the reason why the access request is prohibited.

### Other Embodiments

Although the embodiment of the present disclosure has been described above, the present disclosure is not limited to the embodiment described above, and various modifications can be made to implement the present disclosure.
(a) The API gateway 30 and the method thereof described in the present disclosure may be implemented by a dedicated computer provided by configuring a processor and a memory programmed to execute one or more functions embodied by a computer program. Alternatively, the API gateway 30 and the method described in the present disclosure may be implemented by a dedicated computer provided by a processor with one or more dedicated hardware logic circuits. Alternatively, the API gateway 30 and the method described in the present disclosure may be implemented by one or more dedicated computers provided by a combination of a processor and a memory programmed to execute one or more functions and a processor including one or more hardware logic circuits. The computer program may be stored in a computer-readable non-transitionary tangible storage medium as an instruction to be executed by the computer. The method for implementing the functions of the respective units included in the API gateway 30 does not necessarily need to include software, and all of the functions may be implemented with the use of one or multiple hardware.
(b) Multiple functions of one element in the described above embodiment may be implemented by multiple elements, or one function of one element may be implemented by multiple elements. Further, multiple functions of multiple elements may be implemented by one element, or one function implemented by multiple elements may be implemented by one element. A part of the configuration of the above embodiments may be omitted as appropriate. At least a part of the configuration in one embodiment may be added to or substituted for the configuration of another embodiment.
(c) In addition to the access control device described above, the present disclosure can be implemented in various forms, such as a system that includes the access control device as a component, a program for causing a computer to function as the access control device, a non-transitory tangible storage medium such as a semiconductor memory on which the program is stored, and an access control method.

What is claimed is:

1. An access control device mounted on a vehicle, the access control device comprising:
at least one of (i) a circuit and (ii) a processor with a memory storing computer program code executable by the processor, the at least one of the circuit and the processor configured to cause the access control device to:
accept an access request to each of at least one application programming interface of a plurality of application programming interfaces each corresponding to vehicle data or a function of the vehicle, from an application that uses the vehicle data or the function of the vehicle via the at least one application programming interface; and
acquire movement information indicating that the vehicle has moved from a first region to a second region; and
a controller configured to
control the access request to the at least one application programming interface based on an authorization policy that defines an access privilege from the application to each of the plurality of application programming interfaces according to a region, and
change a control of the access request to the at least one application programming interface when the movement information is acquired.

2. The access control device according to claim 1, further comprising
a policy storage that stores the authorization policy,
wherein
the authorization policy stored in the policy storage includes a first policy and a second policy, and
the controller refers to the first policy according to the first region among the authorization policy stored in the policy storage before the movement information is acquired, and refers to the second policy according to the second region among the authorization policy stored in the policy storage after the movement information is acquired.

3. The access control device according to claim 1, wherein
the controller is configured to individually permit or prohibit the access request to each of the at least one application programming interface based on the authorization policy.

4. The access control device according to claim 1, wherein
the authorization policy defines a priority of the access request from each of a plurality of applications corresponding to a different service to each of the plurality of application programming interfaces, and
the controller is configured to change the priority of the access request based on the authorization policy when the movement information is acquired.

5. The access control device according to claim 1, wherein
the controller is configured to
individually permit or prohibit the access request to each of the at least one application programming interface based on the authorization policy, and
in a case of prohibiting any of the access request based on the authorization policy, when a vehicle user permits the access request prohibited by the controller, change a state of the access request from a prohibited state to a permission state.

6. The access control device according to claim 1, wherein
the controller is configured to
individually permit or prohibit the access request to each of the at least one application programming interface based on the authorization policy, and
when prohibiting any one of the access request, (i) notify the application that any one of the access request has been prohibited and (ii) propose a process using an accessible application programming interface among the plurality of application programming interfaces instead of a process using an application programming interface according to the prohibited access request.

7. The access control device according to claim 1, wherein
the controller is configured to
individually permit or prohibit the access request to each of the at least one application programming interface based on the authorization policy, and
when any of the access request has been prohibited, notify the application that any of the access request has been prohibited and notify the application of a reason for prohibition.

8. An access control method executed by an in-vehicle device mounted on a vehicle, the access control method comprising:
accepting an access request to each of at least one application programming interface of a plurality of application programming interfaces each corresponding to vehicle data or a function of the vehicle, from an application that uses the vehicle data or the function of the vehicle via the at least one application programming interface;
acquiring movement information indicating that the vehicle has moved from a first region to a second region;
controlling the access request to the at least one application programming interface based on an authorization policy that defines an access privilege from the application to each of the plurality of application programming interfaces according to a region; and
changing control of the access request to each of the at least one application programming interface when the movement information is acquired.

9. A non-transitory computer-readable storage medium storing a program configured to cause an in-vehicle device mounted on a vehicle to:
accept an access request to each of at least one application programming interface of a plurality of application programming interfaces each corresponding to vehicle data or a function of the vehicle, from an application that uses the vehicle data or the function of the vehicle via the at least one application programming interface;
acquire movement information indicating that the vehicle has moved from a first region to a second region;
control the access request to each of the at least one application programming interface based on an authorization policy that defines an access privilege from the application to each of the plurality of application programming interfaces according to a region; and
change control of the access request to each of the at least one application programming interface when the movement information is acquired.
